(19) United States
(12) Patent Application Publication
(10) Pub. No.: US 2002/0164775 A1
(43) Pub. Date: Nov. 7, 2002

(54) Compositions and methods for destroying allergens

(76) Inventor: Charles Christopher Swensen, Crofton, MD (US)

Correspondence Address: ARMSTRONG, WESTERMAN & HATTORI, LLP, Suite 220, 502 Washington Avenue, Towson, MD, 21204, US

(21) Appl. No.: 10/085,151

(22) Filed: Feb. 27, 2002

Related U.S. Application Data
(60) Provisional application No. 60/272,632, filed on Mar. 1, 2001.

(51) Int. Cl. C12S 9/00

(52) U.S. Cl. 435/263; 435/264

(57) ABSTRACT

Applying bacterial spores to fabric to rid the fabric of allergens. The spores are allowed to remain on the fabric for an extended period of time after application so as to continuously rid the fabric of allergens. Also, contemplated by this invention is applying the spores to a surface to rid the surface of allergens.

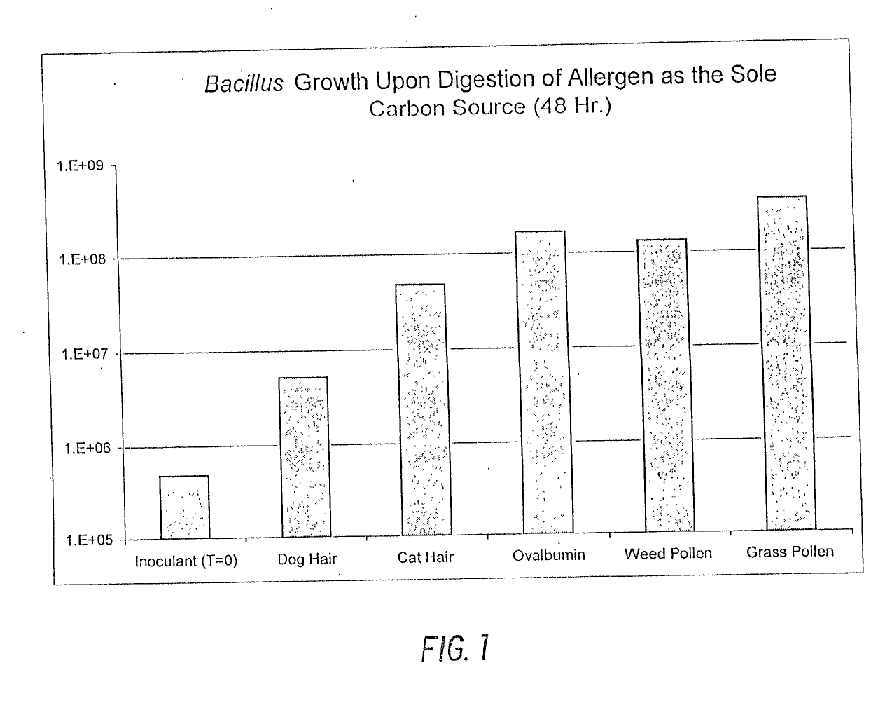

### RELATED APPLICATIONS

This application is related to Provisional Application Serial No. 60/272,632 filed Mar. 1, 2001.

### FIELD OF THE INVENTION

The herein disclosed invention is useful in ridding various substrates of allergens.

### BACKGROUND OF THE INVENTION

Allergens in the environment are a problem for allergic individuals. This includes those suffering from asthma. Typical examples of allergens in the environment found to be harmful to individuals are mold, dust mites, grass and tree pollens, weed pollen, dog, cat and horse dander, ovalbumin, etc. The build up of these allergens in the environment causes allergic reactions. The allergic reactions may range from the unpleasantness of a runny nose and watering eyes to an all out life threatening asthma attack. The key to avoiding these allergic reactions, as many allergy physicians inform, is to reduce allergens in the environment.

In the past, in order to reduce the amount of allergens in the environment, engineering controls, such as mattress, boxspring, and pillow encasings; vent filters; HEPA air cleaners; electrostatic “Whole House” air filters/cleaners; and high efficiency vacuum bags have been used. Other steps to reduce the amount of allergens in the environment have been to wash sheets, blankets, pads, curtains and carpets frequently in hot water. Keeping the relative humidity low also helps control mold and dust mite counts. Tannic acid, boric acid, and pesticides such as disodium octaborate tetrahydrate have been used to reduce allergens. Out of all of the suggested solutions, encasing the mattress, boxspring, and pillow work the best, because encasing actually creates a barrier between the allergen-source and the allergy sufferer. The use of vent filters and HEPA air cleaners or electrostatic “Whole House” air filter/cleaners are not as effective in getting rid of dust mites, because the dust mites live in the carpet, bedding, or drapery, and are not airborne. Controlling the relative humidity helps to keep dust mite populations from thriving, but may add to the problem of dry skin and sinuses, which may also cause irritation problems. Spraying tannic acids onto carpets and fabrics may help neutralize some allergens, but it does not help with dust mites and may also cause irritation problems. Finally, the introduction of boric acid or disodium octaborate tetrahydrate to the carpet or draperies may kill the dust mites, but will also leave behind a residue which will be irritating to pets and people.

### PRIOR ART PATENTS

Lin et al (U.S. Pat. No. 5,863,882) teaches formulations containing bacterial spores. These formulations are to be used for cleaning and sanitizing bathroom fixtures, sinks, toilet bowls, contaminated surfaces and sewage systems. The composition is used primarily in wastewater and sewage collection systems.

Lawler et al (U.S. Pat. No. 6,083,737) discloses a novel strain of Bacillus bacteria for degrading fat and protein. The bacterial strain is to be used for treating wastewater, laundry and dish detergents, drain cleaners and spot removers.

Hahn et al (U.S. Pat. No. 5,769,900) teaches mixtures of various starch-degrading enzymes (amylases) used to desize textiles sized with starch.

Screws et al (U.S. Pat. No. 5,707,858) teaches the use of cellulase enzymes to treat cellulosic fabric to improve handle and appearance.

McDevitt et al (U.S. Pat. No. 6,051,033) teaches a method of treating wool, wool fibers or animal hair with proteolytic enzymes and tranglutaminase for the purpose of improving shrink-resistance, handle, wettability, as well as, improving other fabric qualities.

Waksman (U.S. Pat. No. 1,432,312) teaches improving silk fibers by treating them with proteolytic bacteria to rid the silk filbers of gum contaminating the silk. This process produces a cost-saving in the cost of soap usually used to rid the silk of gum. The patent method employs Bacillus fluorescence liquefaciens and Bacterium mycoides.

None of the prior art cited teaches bacterial spores used for the purpose of the herein disclosed invention.

With the background above set forth and the prior art patents in mind, a primary object of this invention is to provide a product and method of use which safely and effectively rids the environment of allergens.

### BRIEF SUMMARY OF THE INVENTION

The herein disclosed invention is an Allergen Neutralizer ready to use spray and/or concentrate made up of all natural ingredients. The formulation has three sets of components. The first set of components is an odor counteractant, which, when sprayed into the environment, will immediately introduce a pleasant fragrance to the area. The second set of components of the formulation reacts with odor causing gases, both organic and inorganic and converts the odor into odorless, stable, and non-toxic compounds. The third set of components act to materialize any organic compounds left on the surface which may cause an allergic reaction. These organic compounds include allergens, such as dog or cat hair or dander, ovalbumin, weed pollen, grass pollen, and dust mite remains and excretions.

The herein disclosed invention also involves the use of bacterial spores to reduce the amount of dust mites by inhibiting the growth of the dust mite population. Dust mites and the bacteria demand the same sources of nutrients, such as skin and hair remains or dander. The bacteria, however, are more efficient at getting to the nutrients first, which allows the bacterial population to thrive, and the dust mite population to diminish. Dust mites and bacteria not only have the same desire for certain nutrients, but they also will thrive under the same type of conditions. For example, if it is dry, the dust mite population will be low, and the bacteria will revert to the spore state. If it is moist and humid, the dust mite population will increase. Dust mites and bacteria will also thrive in the moist and humid conditions and the features of this invention will keep the dust mite population from growing.

The bacteria will also act to digest or denature many allergens, since the allergens are proteins, lipoproteins, or glycoproteins in structure. The bacteria will use those allergens as a nutrient source, thus reducing the level of allergens available to cause an allergic reaction.

The Allergen Neutralizer of this invention is biodegradable; and friendly to the environment and to humans. It is non-toxic, non-irritating, solvent free, and safe on all surfaces. It is designed primarily for use on fabric, upholstery, carpet, etc., but can also be used on porous or non-porous surfaces.

The Allergen Neutralizer composition is especially effective in neutralizing odors caused by pesticides, fertilizers, sulfur compounds, mercaptans, ammonia, amines, etc. It eliminates smoke odor, fish odor, pet smells, musty odors, baby's diaper odors, vomit smell, restroom odors, kitchen odors, and many other foul odors.

The Allergen Neutralizer can be used following carpet extraction. Carpet extraction removes many of the dust mites and their food sources, but also introduces moisture to the carpet, which allows the dust mite population to repopulate and flourish. By using Allergen Neutralizer on wet carpets, you further reduce the dust mite food source and the bacteria will flourish until the carpet is dry. While the bacteria are flourishing, they will also digest any allergens left behind by the excrements of any dust mites that are able to survive.

A typical composition of this invention is as follows:

| Ingredient | Supplier | Precentage |
|---|---|---|
| Water | | QS |
| Ultra Freshener | Horizon Aromatics | 5-10 |
| N100 (Exhibit A) | 1500 B. Newport Pike, Suite 201 | |
| | Wilmington, DE 19804 | |
| | 301-993-8305 | |
| Fragrance | | 0-.15 |
| Bacterial Cultures* | | 5-10 |

*The bacterial cultures are subtilus, amyloliquefaciens, licheniformis, megaterium, pumilus (2 strains), all Bacillus strains. The species of Bacillus spores which are operative in this invention are ascertainable by workers skilled in the art.

Broadly considered an effective amount of the bacterial spores would range as follows:

| | |
|---|---|
| Bacillus amyloliquefaciens | 2.0 × 10⁸ to 3.3 × 10⁸ |
| Bacillus licheniformis | 2.0 × 10⁸ to 3.3 × 10⁸ |
| Bacillus megaterium | 2.0 × 10⁸ to 3.3 × 10⁸ |

The exact amounts of spores can be higher than those herein set forth because the spores are relatively non-toxic. The most optimum concentration of spores based on the disclosure herein can be determined by those skilled in the art.

In a preferred embodiment, the blend of the spore bacteria strains was as follows:

| | |
|---|---|
| Bacillus amyloliquefaciens | 2.5 × 10⁸ |
| Bacillus licheniformis | 2.5 × 10⁸ |
| Bacillus megaterium | 2.5 × 10⁸ |

Allergen Digestion by Bacillus Strains. The figure herein sets forth the result of the following experiment. The experiment shows an increase in bacterial concentration in a microbiological medium containing only one carbon source indicates digestion of the carbon containing material. A Basal Salts medium with carbon source absent was provided for allergen digestion studies. This defined medium provides all the required macro- and micro-nutrients required for growth, except for carbon. The medium as then supplemented with different allergens (one allergen per study). The allergen represents the only carbon source present for digestion. A known Bacillus inoculum concentration was added to the medium and incubated at 37 C. for 48 hours. After incubation, the bacterial concentration was enumerated. The attached figure demonstrates the increase in bacterial concentration when the following compounds were provided as sole carbon sources:

Dog Hair
Cat Hair
Ovalbumin
Weed Pollen
Grass Pollen

Results show that the bacterial concentration significantly increased compared to the initial inoculum. These results are indicative of the bacteria's ability to utilize the compound as a sole carbon source (digestion). Beyond bacterial enumeration, in the case of the dog and cat hair, visible digestion was also noted compared to the controls.

Bacillus microorganisms are the preferred genus of microorganism because they are able to produce protected spore forms. Under favorable conditions, the spores become activated to the active form of bacteria.

The allergen neutralizing composition of this invention is designed to remain on the carpet, fabric or hard surface, for an extended period of time, for example for at least 24 hours or longer. The composition finds use in residential as well as commercial applications. The inventors contemplate the use of their allergen neutralizer to be applied to newly manufactured carpets as the carpet leaves the factory. In regular use, the allergen neutralizer is designed to stay applied for 2-3 weeks. The preferred formulation of the allergen neutralizer is a spray, however, liquid and dry forms are contemplated. The concept of allergen neutralization envisioned by the inventors is distinct from the cleaning concept of the prior art in that the bacterial spores are left in place on the substrate and not removed. In this way the spores continuously act to remove allergens.

In tests performed, indicate that the composition of this invention may cause a beneficial reduction of Fel d 1 (cat allergen) and Der p 2 (dust mite allergen), employing the vegetative state of bacillus amyloliquefaciens, bacillus licheniformis and bacillus megaterium.

In a preferred embodiment of this invention, a combination of bacillus amyloliquefaciens, bacillus licheniformis and bacillus megaterium were employed.

The inventors contemplate that the allergen neutralizer composition of this invention will be applied after the surface, such as, fabric (e.g., curtain) or carpet is clean so as to provide a long-lasting anti-allergenic effect.

A typical method for employing the composition of this invention involves vacuuming and then neutralizing allergens attaching to the surface during the ordinary course of use.

Applicants do not wish to be bound by any specific theory of operation.

Advantages of using the composition of this invention are:

1. The composition is biodegradable and environmentally friendly.

2. The composition is non-toxic.

3. The composition stays in place on the fabric or material substrate to continuously neutralize allergens.

### BRIEF DESCRIPTION OF THE DRAWINGS

The FIGURE describes the affect of Bacillus growth upon digestion of allergen when the allergen is the sole source of carbon.

### SUPPLEMENTAL LABORATORY TEST

The herein disclosed invention has been tested in laboratory tests, employing allergen digestion as seen during ELISA analysis, in vitro testing on the effects of the bacillus bacteria on specific allergens showed a reduction in the allergens. The ELISA test method was used to record the level of allergens before and after contact. Allergens, such as Der p 2 and Fel d 1 showed a marked reduction.

Obviously, many modifications may be made without departing from the basic spirit of the present invention. Accordingly, it will be appreciated by those skilled in the art that within the scope of the appended claims, the invention may be practiced other than has been specifically described herein.

What is claimed is:

1. A method of ridding fabric of allergen comprising applying spores of Bacillus microorganism to the fabric and allowing the Bacillus microorganism to remain in place on said fabric for an extended period of time to allow the spores to neutralize the allergen.

2. A method of ridding a surface of an allergen comprising applying spores of Bacillus microorganism to the surface and allowing the Bacillus to remain in place on said surface for an extended period of time to allow the spores of the Bacillus microorganism to neutralize the allergen.

3. The method of claim 2 wherein the spores of Bacillus microorganism remain on the surface for at least 24 hours.

4. The method of claim 3 wherein the surface to be treated is a carpet fabric or hard surface.

5. A composition for ridding a surface of allergen comprising applying to said surface in effective amounts the spores of a mixture of bacillus amyloliquefaciens, bacillus licheniformis and bacillus megaterium.

6. The composition of claim 5 wherein the mixture of spores is in the amounts of

| | |
|---|---|
| Bacillus amyloliquefaciens | 2.0 × 10⁸ to 3.3 × 10⁸ |
| Bacilus licheniformis | 2.0 × 10⁸ to 3.3 × 10⁸ |
| Bacillus megaterium | 2.0 × 10⁸ to 3.3 × 10⁸ |

7. The composition of claim 6 wherein the mixture of spores is in the amounts of:

| | |
|---|---|
| Bacillus amyloliquefaciens | 2.5 × 10⁸ |
| Bacillus licheniformis | 2.5 × 10⁸ |
| Bacillus megaterium | 2.5 × 10⁸ |

8. The composition of claim 7 containing a fragrance.

9. A method for ridding a surface of an allergen comprising applying to said surface the composition of claim 5.
